(19) United States
(12) Patent Application Publication
(10) Pub. No.: US 2015/0286254 A1
(43) Pub. Date: Oct. 8, 2015

(54) Tablet Projecting System with Modular External Connection

(71) Applicant: Shui Ho Hung, TAIPEI CITY (TW)

(72) Inventor: Shui Ho Hung, TAIPEI CITY (TW)

(21) Appl. No.: 14/320,189

(22) Filed: Jun. 30, 2014

Related U.S. Application Data
(60) Provisional application No. 61/974,533, filed on Apr. 3, 2014.

(51) Int. Cl. G06F 1/16; G06F 3/041

(52) U.S. Cl. CPC G06F 1/1656; G06F 3/0412; G06F 1/1645; G06F 1/1643; G06F 2200/1635

(57) ABSTRACT

A tablet projecting system with modular external connection is provided. The tablet projecting system includes a tablet projector and a first external module, the tablet projector further includes a processing unit, a touch display module and an image projecting module, the touch display module receives a control motion, the processing unit generates a control signal corresponding to the control motion and the image projecting module projects an image information accordingly, the first external device has a transmission terminal, the tablet projector has a transmission port, and electricity supply is provided to the tablet projector by the first external module via electric connection between the transmission terminal and the transmission port while the first external module is assembled with the tablet projector.

### CROSS-REFERENCE TO RELATED APPLICATIONS

This application claims the benefit of the filing date of U.S. Provisional Application No. 61/974,533, filed on 2014 Apr. 3, in the United States Patent and Trademark Office, the disclosure of which is incorporated herein in its entirety by reference.

### BACKGROUND OF THE INVENTION

1. Technical Field

The present invention relates to a projecting system, and more particularly to a tablet projecting system with modular external connection.

2. Description of Related Art

As rapid development of display technology, various new display device are getting rid of the stale and bringing forth the fresh, new products such as liquid crystal display (LCD), digital television, digital projector. Meanwhile, entirely separate development trend is derived in specific display device corresponding to different demands of consumers. One of development trend is family entertainment, to satisfy such demand, development of home display device, such as liquid crystal display (LCD), digital television, digital projector, . . . etc are targeted in big-scale, high definition, high resolution and 3D imaging.

In another aspect, the other development trend is directed to personal use or commercial applications wherein convenience is no doubt a main subject. Hence, portable, mobility, multiple-function and power-saving are taking serious consideration in tablet computer, personal display device or small projector in order to be applied for personal use or commercial applications. Therefore, a tablet projector with both functions of tablet computer and projector integration is involved.

The advantages of the tablet projector includes: the tablet projector may perform like a normal tablet computer in common use, and the tablet projector may also projecting an image information in order to share with other viewers during commercial exhibition, presentation or image sharing, it is to say, it is convenient and fully satisfying user's different requirement with one tablet projector. Both mobility and power endurance are taking into account in tablet projector design, however, mobility requirement will lead to slim type and either size and weight of such tablet projector have to be reduced which may causes potentially confliction, for integrated battery module in such tablet projector is bound to minimized accordingly, in current battery technology, it may cause low power endurance problem with limited size, but high power endurance is indispensable for long-term commercial exhibition, presentation or image sharing. In a word, if manufacturers emphasize on durability of the battery, volume of the battery cannot be minimized notably; in other hands, if manufactures insist on volume decreasing, then they will face challenge of power durability to the tablet projector. It is really a dilemma for the manufactures.

In view of the foregoing, there exist problems and disadvantages in the related art still unsolved. However, those skilled in the art sought vainly for a solution. There is an urgent need in the related field to improve both volume and durability of the tablet projector.

### BRIEF SUMMARY OF THE INVENTION

In view of the above, the primary objective of the present invention is to provide a tablet projecting system with modular external connection.

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one exemplary embodiment, the invention is directed to a tablet projecting system with modular external connection, comprises a tablet projector and a first external module, the tablet projector comprises a processing unit; a touch display module and an image projecting module, the touch display module electrically connects to the processing unit, the touch display module receives a control motion, the processing unit generates a control signal corresponding to the control motion, the image projecting module electrically connects to the processing unit, an image information is projected via the image projecting module according to the control signal, the first external module has a transmission terminal, and the tablet projector has a transmission port, wherein electricity supply is provided to the tablet projector by the first external module via electric connection between the transmission terminal and the transmission port while the first external module is assembled with the tablet projector.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

First, Overall size and weight can be minimized by separating battery module and other components from the tablet projector, and such battery module and components are constitute as independent modular external device for user's convenience in carry and usage. Besides, external modules for power supply may be assembled with the tablet projector easily and provide power for long-term use, it is to say, present invention combines both mobility and power endurance, and reduces user's burden remarkably.

Since all the transmission terminals, transmission ports, joint members and joint portions can be assembled easily and plugged-and-play, the external modules for power supply may be combined or stacked together like building block to form a parallel power supply circuit to perform modular power supplying, and power endurance of the tablet projecting system in present invention can be improved by extra external module assembly, which is easily for installation and operation.

Besides, conception of present invention is to separate supplementary components with different functions from the tablet projector and modular external devices are introduced respectively, users may purchase the external modules with various functions and assemble with the tablet projector according to their hobbit or needs. In other words, the tablet projecting system in present invention can be customized, personalized and exclusive to user's demands.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram illustrating a tablet projecting system with modular external connection according to an exemplary embodiment of the present invention;

FIG. 2 is a structural diagram illustrating a tablet projecting system with modular external connection according to an exemplary embodiment of the present invention;

FIG. 3A is another structural diagram illustrating a tablet projecting system with modular external connection according to an exemplary embodiment of the present invention;

FIG. 3B is another structural diagram illustrating a tablet projecting system with modular external connection according to an exemplary embodiment of the present invention;

FIG. 4 is another structural diagram illustrating a tablet projecting system with modular external connection according to an exemplary embodiment of the present invention;

FIG. 5 is a schematic diagram illustrating a tablet projecting system with modular external connection according to another exemplary embodiment of the present invention;

FIG. 6A is a structural diagram illustrating a tablet projecting system with modular external connection according to another exemplary embodiment of the present invention;

FIG. 6B is another structural diagram illustrating a tablet projecting system with modular external connection according to another n exemplary embodiment of the present invention;

FIG. 7 is another structural diagram illustrating a tablet projecting system with modular external connection according to another exemplary embodiment of the present invention;

FIG. 8 is a schematic diagram illustrating a tablet projecting system with modular external connection according to another exemplary embodiment of the present invention;

FIG. 9 is a structural diagram illustrating a tablet projecting system with modular external connection according to another exemplary embodiment of the present invention; and

FIG. 10 is a structural diagram illustrating a tablet projecting system with modular external connection according to another exemplary embodiment of the present invention.

### DETAILED DESCRIPTION OF THE INVENTION

The detailed description and technical contents of the present invention will be explained with reference to the accompanying drawings. However, the drawings are for illustration only and cannot be used to limit the present invention.

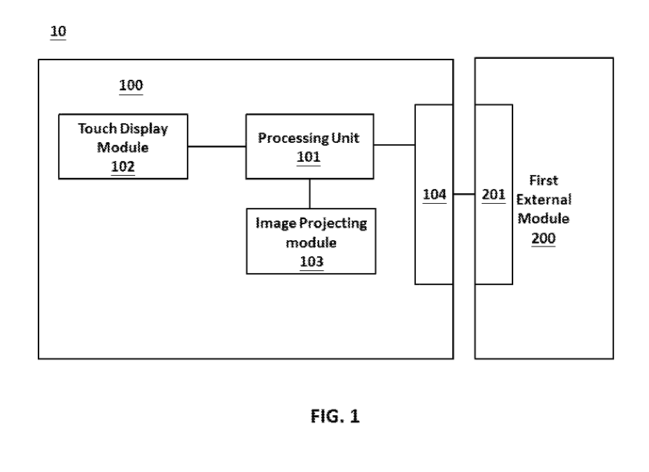

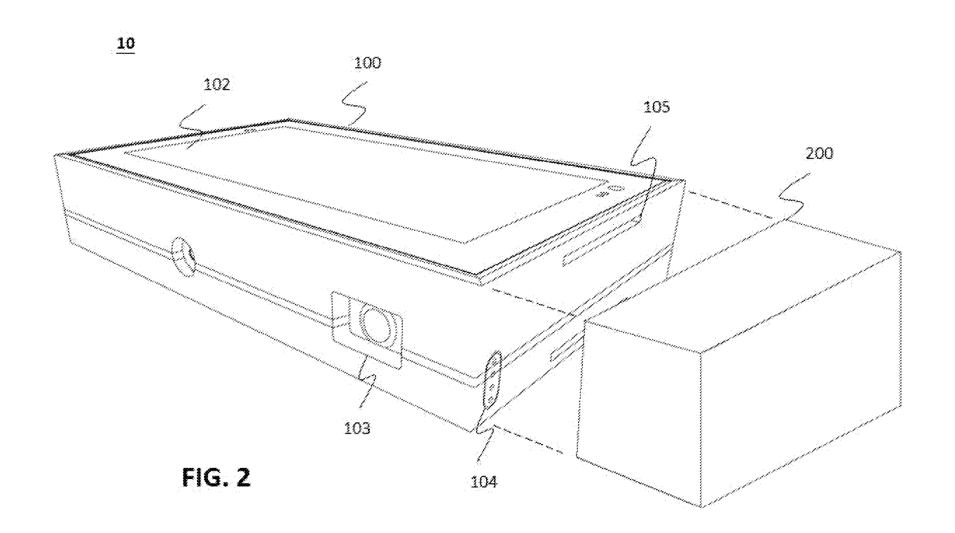

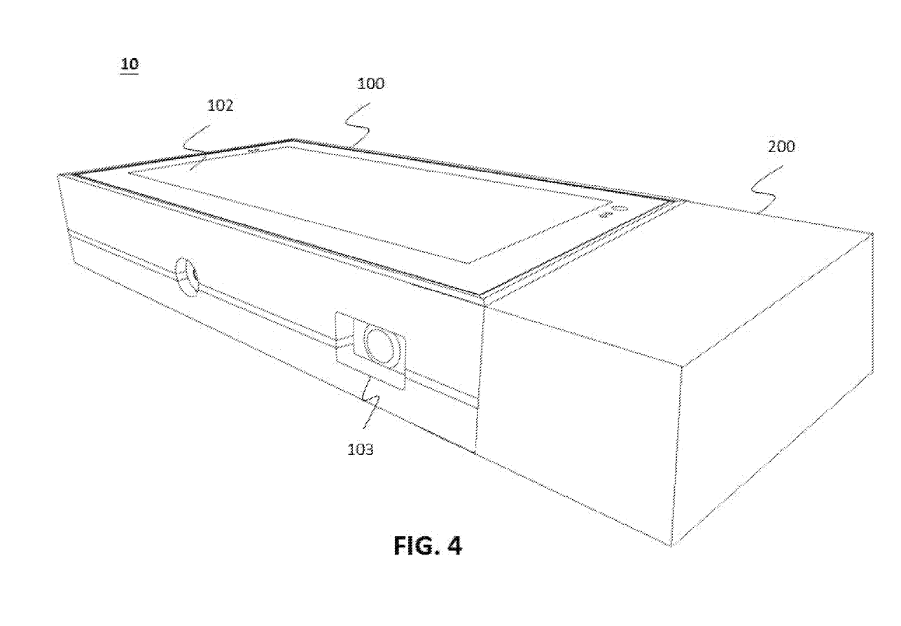

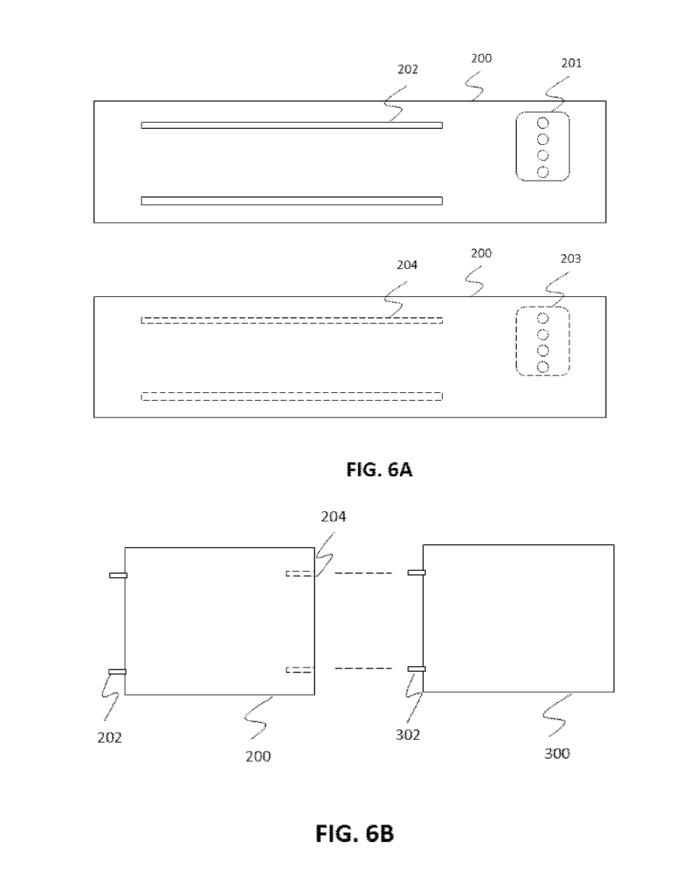

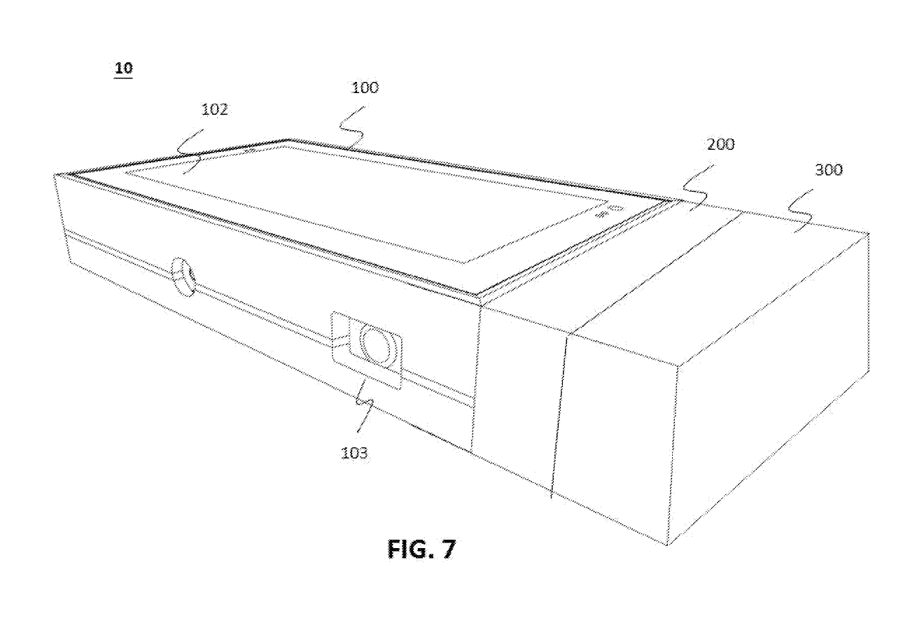

Several exemplary embodiments of the present disclosure are described with reference to FIGS. 1 through 10, which generally relate to a tablet projecting system with modular external connection. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 1 to FIG. 4 are a schematic diagram and structural diagrams illustrating a tablet projecting system with modular external connection according to a first embodiment of the present invention. Referring to FIG. 1 to FIG. 4, in the first embodiment, a tablet projecting system 10 with modular external connection includes a tablet projector 100 and a first external module 200, the tablet projector 100 in this embodiment can be but not limited to a mobile projector, a tablet computer or a laptop equipped with image projecting module. The tablet projector 100 includes a processing unit 101, a touch display module 102, an image projecting module 103, a transmission port 104 and a first joint portion 105, wherein the touch display module 102 is electrically connected to the processing unit 101, the touch display module 10 receives a control motion, for example, a slide motion or an identifiable gesture from users, the processing unit 101 generates a control signal corresponding to the control motion. The image projecting module 103 is electrically connected to the processing unit 101, the image projecting module 103 projects an image information according to the control signal. Hence, the tablet projector 100 is capable to detect a control motion via the touch display module 102, and executes an operation function, such as picture viewing, by the processing unit 101, and projects the picture synchronously via the image projecting module 103.

It is noted that the tablet projector 100 illustrated in this embodiment may includes other hardware components, such as image acquisition module, audio playback module or network connection module and is not limited as mentioned. The following description will focus on essential components in the tablet projector 100 as shown in FIG. 1 for emphasizing the technical features of the present invention. It will also make the description of the present invention clear enough and fully disclosed for people with ordinary skill in this art to practice according thereto.

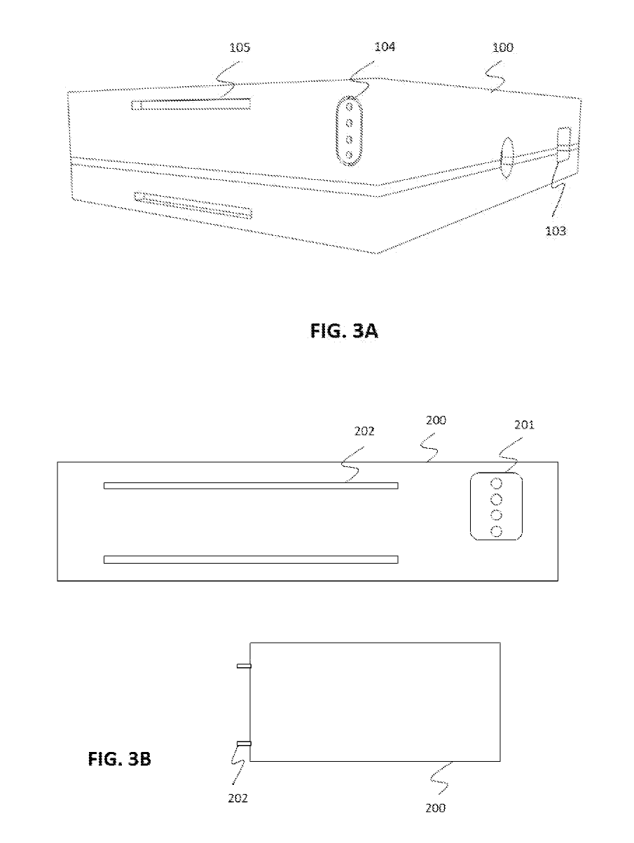

As shown in FIG. 3A, the transmission port 104 and the first joint portion 105 are disposed in pair on a lateral side or a bottom side of the tablet projector 100. Location and amount of the transmission port 104 and the first joint portion 105 can be modified or varied according to user's demands and no limited as illustrated in figures.

As shown in FIG. 3B, the first external module 200 is an independent module for external connection to the tablet projector 100, hardware components and addition functions of the first external module 200 are depended on manufacturers' design. For example: The first external module 200 can be an external battery module for power supply, an external image acquisition module for image acquiring, or an external loudspeaker for audio playback and not limited as mentioned. A transmission terminal 201 and a first joint member 202 are equipped in pair on the first external module 200. The transmission terminal 201 corresponds to the transmission port 104 of the tablet projector 100, and both the transmission terminal 201 and the transmission port 104 are followed a transmission protocol defined by manufacturers, which includes four electrical terminals: a positive terminal(+), a negative terminal(−), a first signal terminal(SIN1) and a second signal terminal(SIN2), wherein the positive terminal(+) and the negative terminal(−) are applied to power supply, and the first signal terminal(SIN1) and the second signal terminal(SIN2) are applied to data transmission. Owing to plug-and-play function in mentioned transmission terminal 201 and transmission port 104, power supply or data transmission between the first external module 200 and the tablet projector 100 can be activated via such transmission interface once the transmission terminal 201 and the transmission port 104 are connected.

However, transmission protocol of the transmission terminal 201 and the transmission port 104 defined in this embodiment is not limited as mentioned. Conventional data transmission protocol such as Universal Serial Bus (USB), RS232 can also be deployed by people with ordinary skill in present invention without departing from the spirit of the present invention.

As described above, the first joint member 202 of the first external module 200 corresponds to the first joint portion 105 of the tablet projector 100 in order to make the first external module 200 and the tablet projector 100 be assembled and fastened. Therefore, the first joint member 202 is combined with the first joint portion 105, and the transmission terminal 202 is electrically connected to the transmission port 104 while the first external module 200 is associated with the tablet projector 100. Clamping, screw locking, fixing or line connection, . . . etc are adaptable combination ways of the first joint member 202 and the first joint portion 105. Different combination methods can be considered by people with ordinary skill to apply without departing from the spirit of the present invention. Two preferred patterns of combination way will be described as following:

In a first pattern of this embodiment, the first joint member 202 of the first external module 200 is a convex part, and the first joint portion 105 of the tablet projector 100 is a notch, hence, the first joint member 202 is fastened with the first joint portion 105 while the first external module 200 is assembled with the tablet projector 100; In a second pattern of this embodiment, the first joint member 202 of the first external module 200 and the first joint portion 105 of the tablet projector 100 are magnets with opposite magnetic, and the first joint member 202 is absorbed with the first joint portion 105 while the first external module 200 is assembled with the tablet projector 100. Both mentioned patterns of combination way are simple and convenient for users to complete. Furthermore, mentioned patterns of combination way can prevent collision or shake and will not be loosed easily.

As mentioned above, when users operate the tablet projector 100 for long-time commercial exhibition, presentation or image sharing with others, they only have to place the tablet projector 100 on a surface and associate the first external module 200 (external battery module herein) with the tablet projector 100, the first joint member 202 and the first joint portion 105 can be combined together and fastened easily, and the first external module 200 can be power supply for tablet projector 100 directly via electrical connection between the transmission terminal 201 and the transmission port 104. As result, the tablet projector 100 can maintain long-time operation without outer power line connecting and easily for usage. Moreover, since electrical power can be provided by the first external module 200, high durable integrated power source will not be essential equipment in the tablet projector 100 (or even no integrated power source is necessary) and overall weight and size of the tablet projector 100 is expected to be minimized for user's convenience in carry and usage. As result, users can easily remove the first external module 200 from the tablet projector 100 and carry the tablet projector 100 by themselves for personal usage or outdoor usage, which is convenient.

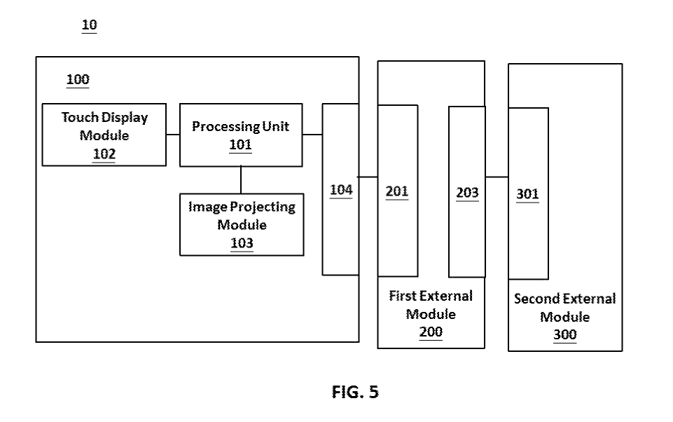

FIG. 5 to FIG. 7 are a schematic diagram and structural diagrams illustrating a tablet projecting system with modular external connection according to a second embodiment of the present invention. Referring to FIG. 5 to FIG. 7, and FIG. 1 to FIG. 4 as well, the tablet projecting system 10 with modular external connection in the second embodiment further includes a second external module 300, a transmission terminal 301 and a second joint member 302 are disposed in pair on the second external module 300 which similar to the first external module 200, and in this embodiment, not only the transmission terminal 201 and the first joint member 202 are disposed in pair on the first external module 200 as disclosed in the first embodiment, but a transmission port 203 and a second joint portion 202 are also disposed on other side of the first external module 200, detailed specification of transmission terminal, transmission ports, each joint members and joint portion are the same as mentioned in the first embodiment and will not be repeated again.

As mentioned above, when the second external module 300 (external battery module herein) is assembled with the first external module 200 (external battery module herein), the second joint member 302 is combined with second joint portion 204, and electricity supply is provided to the tablet projector 100 by a parallel circuit with the first external module 200 and the second external module 300 via electric connection between the transmission terminal 301 of the second external module 300 and the transmission port 203 of the first external module 200. Therefore, electric capacity of the first external module 200 and the second external module 300 can be accumulated in power supply, for example: maximum electric capacity of the first external module 200 is 2000 mAh, and maximum electric capacity of the second external module 300 is also 2000 mAh, then the tablet projector 100 may acquires 2000*2=4000 mAh from the first external module 200 and the second external module 300 through their combination as mentioned above.

Consequently, when users operate the projecting system 10 in this embodiment, They only have to associate the first external module 200 with the tablet projector 100 and the second external module 300 with the first external module 200, just like stacking building block together, as mentioned, electricity supply is provided to the tablet projector 100 by the parallel circuit with the first external module 200 and the second external module 300 via electric connection, and power endurance of the tablet projector 100 can be improved effectively and quickly for long-time operation. Furthermore, since the first external module 200 and the second external module 300 are similar in structure which can be mass production by manufacturers. Theoretically, power durability of the tablet projector 100 can be improved and users may extend operation time effectively by simply keep associating the external modules.

It is noted that although in this embodiment, only two external modules: the first external module 200 and the second external module 300 are taken as example for power supply to the tablet projector 100, but combination way and amount of the external module can be modified according to users demands and not be limited as mentioned.

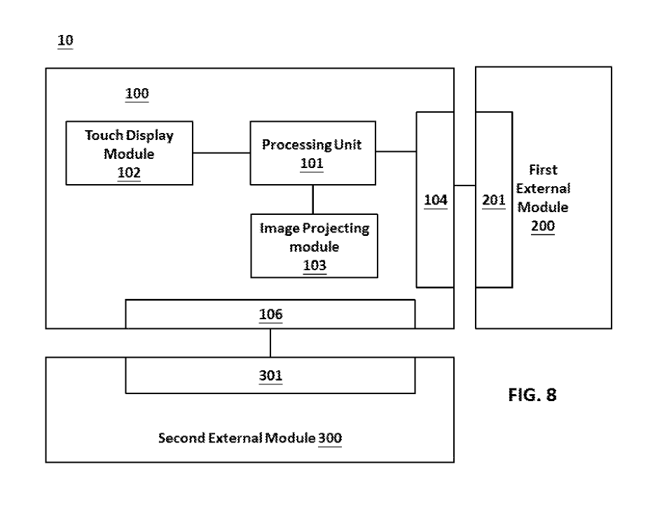

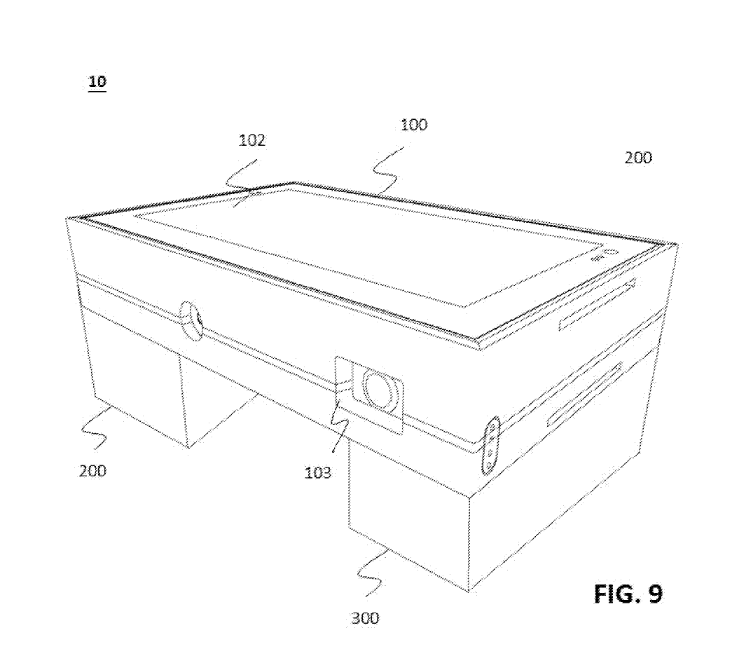

FIG. 8 to FIG. 10 are a schematic diagram and structural diagrams illustrating a tablet projecting system with modular external connection according to a third embodiment of the present invention. Referring to FIG. 8 to FIG. 10, and FIG. 1 to FIG. 4 as well, difference between the tablet projecting system 10 in the third embodiment and in the second embodiment is that the first external module 200 and the second external module 300 are assembled with the tablet projector 100 respectively. Since not only the transmission port 104 and the first joint portion 105 are disposed on one side of the tablet projector 100, but another transmission port 106 and a second joint portion (not shown) are also disposed on the other side of the tablet projector 100, the first external module 200 and the second external module 300 can be assembled on different side of the tablet projector 100, and electricity supply is provided to the tablet projector 100 by a parallel circuit with the first external module 200 and the second external module 300 via electric connection between the transmission terminal 301 and the other transmission port 106. In other words, even the first external module 200 and second external module 300 are associated with the tablet projector 100 respectively as shown in FIG. 9 in this embodiment, electric capacity still can be accumulated in power supply to achieve improvement in power durability of the tablet projector 100.

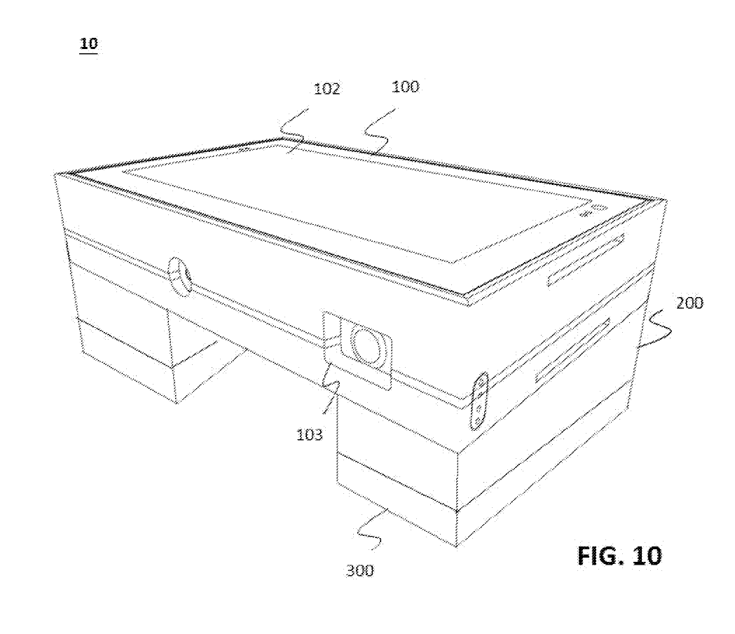

It is noted that combination ways mentioned in the second embodiment may Also applied to the external modules in this embodiment, as shown in FIG. 10, power durability of the tablet projecting system 10 can be improved multiple times. Meanwhile, the external modules can also be used as support to the tablet projector 100. The tablet projector 100 can be located on a surface with support of the first external module 200 and the second external module 300 and prevent the tablet projector 100 from being dropped down due to imbalance. Moreover, the tablet projector 100 can reach better image projecting effect and will not be hided or blocked accordingly.

Referring to FIG. 1 to FIG. 4, difference between the table projecting system 10 in the fourth embodiment and in the first embodiment is, the first external module 200 disclosed in the fourth embodiment is applied for additional function, other than power supply. Two patterns of the first external module will be explain as following:

In a first pattern in this embodiment, the first external module 200 is a portable image acquisition module, the first external module 200 executes image acquiring function corresponding to the control signal from the control unit 101 via electric connection between the transmission terminal 201 and the transmission port 104; In a second pattern, the first external module 200 is a portable audio playback module, the first external module 200 executes audio playing function corresponding to the control signal from the control unit 101 via electric connection between the transmission terminal 201 and the transmission port 104. Therefore, users can simply assemble external modules with different additional functions with the tablet projector 100 and enjoy different additional functions. People with ordinary skill may unifies different additional functions to the tablet projector 100 by assembling mentioned external modules with the tablet projector 100 according to user's demands and is not limited as mentioned.

Furthermore, all technical features disclosed in mentioned four embodiments is practical combining in one tablet projecting system, it is to say, people in this technical area can combine power supply and other additional functions on the tablet projector simultaneously by assembling corresponding external modules with the tablet projector and data transmission and exchanging is executing accordingly. As result, design concept as disclosed in present invention which the tablet projecting system with modular external connection is emerged completely.

In present invention, overall size and weight can be minimized by separating battery module and other components from the tablet projector, and such battery module and components are constitute as independent modular external device for user's convenience in carry and usage. Besides, external modules for power supply may be assembled with the tablet projector easily and provide power for long-term use, it is to say, present invention combines both mobility and power endurance, and reduces user's burden remarkably.

Secondly, since all the transmission terminals, transmission ports, joint members and joint portions can be assembled easily and plugged-and-play, the external modules for power supply may be combined or stacked together like building block to form a parallel power supply circuit to perform modular power supplying, and power endurance of the tablet projecting system in present invention can be improved by extra external module assembly, which is easily for installation and operation.

Besides, conception of present invention is to separate supplementary components with different functions from the tablet projector and modular external devices are introduced respectively, users may purchase the external modules with various functions and assemble with the tablet projector according to their hobbit or needs. In other words, the tablet projecting system in present invention can be customized, personalized and exclusive to satisfy user's demands.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany embodiments.

What is claimed is:

1. A tablet projecting system with modular external connection, comprising:
a tablet projector, comprising:
a processing unit;
a touch display module, electrically connected to the processing unit, the touch display module receiving a control motion, the processing unit generating a control signal corresponding to the control motion;
an image projecting module, electrically connected to the processing unit, an image information projected via the image projecting module according to the control signal;
a first external module, having a transmission terminal, and the tablet projector having a transmission port, wherein electricity supply is provided to the tablet projector by the first external module via electric connection between the transmission terminal and the transmission port while the first external module is assembled with the tablet projector.

2. The tablet projecting system as claimed in claim 1, wherein the first external module further comprises a first joint member, and a first joint portion is disposed on one side of the tablet projector, and the first joint member is combined with first joint portion while the first external module is assembled with the tablet projector.

3. The tablet projecting system as claimed in claim 2, wherein the first joint member of the first external module is a convex part, the first joint portion of the tablet projector is a notch, and the first joint member is fastened with the first joint portion while the first external module is assembled with the tablet projector.

4. The tablet projecting system as claimed in claim 2, wherein the first joint member of the first external module and the first joint portion of the tablet projector are magnets with opposite magnetic, and the first joint member is absorbed with the first joint portion while the first external module is assembled with the tablet projector.

5. The tablet projecting system as claimed in claim 1 further comprising a second external module, the second external having the transmission terminal, and the first external module also having the transmission port, wherein electricity supply is provided to the tablet projector by a parallel circuit with the first external module and the second external module via electric connection between the transmission terminal and the transmission port while the second external module is assembled with the first external module.

6. The tablet projecting system as claimed in claim 5, wherein the second external module further comprises a second joint member, and a second joint portion is disposed on one side of the first external module, and the second joint member is combined with second joint portion while the second external module is assembled with the first external module.

7. The tablet projecting system as claimed in claim 1 further comprising a second external module, the second external having the transmission terminal, and the tablet projector having another transmission port, wherein electricity supply is provided to the tablet projector by a parallel circuit with the first external module and the second external module via electric connection between the transmission terminal and the other transmission port while the second external module is assembled with the tablet projector.

8. The tablet projecting system as claimed in claim 7, wherein the second external module further comprises a second joint member, and a second joint portion is disposed on another side of the tablet projector, and the second joint member is combined with second joint portion while the second external module is assembled with the tablet projector.

9. The tablet projecting system as claimed in claim 1, wherein the first external module is a portable image acquisition module, the first external module executes image acquiring function corresponding to the control signal from the control unit via electric connection between the transmission terminal and the transmission port.

10. The tablet projecting system as claimed in claim 1, wherein the first external module is a portable audio playback module, the first external module executes audio playing function corresponding to the control signal from the control unit via electric connection between the transmission terminal and the transmission port.
